(19) United States
(12) Patent Application Publication
(10) Pub. No.: US 2013/0091301 A1
(43) Pub. Date: Apr. 11, 2013

(54) SYSTEMS AND METHODS FOR REAL-TIME AND ON-DEMAND MULTIMEDIA STREAMING

(71) Applicants: Lon Gibby, Colbert, WA (US); Beau Robert Allen Garner, Spokane Valley, WA (US)

(72) Inventors: Lon Gibby, Colbert, WA (US); Beau Robert Allen Garner, Spokane Valley, WA (US)

(73) Assignee: GIBBY MEDIA GROUP INC., SPOKANE, WA (US)

(21) Appl. No.: 13/702,704

(22) PCT Filed: Jun. 8, 2011
(86) PCT No.: PCT/US11/39665

§ 371 Date: Dec. 7, 2012

Related U.S. Application Data
(60) Provisional application No. 61/352,657, filed on Jun. 8, 2010.
(60) Provisional application No. 61/352,649, filed on Jun. 8, 2010.

(51) Int. Cl. H04L 29/06

(52) U.S. Cl. CPC H04L 29/06027
USPC 709/231

(57) ABSTRACT

Disclosed herein are methods and systems for improving real-time on-demand multimedia streaming for display on computers with different hardware and software constraints. The methods and systems improve multimedia streaming by using a media player with a custom-sized frame, a predefined pixel aspect ratio, a predefined frame-rate, a progressive order, a predefined number of reference frames, a predefined average variable bit rate, and a predefined maximum variable bit rate. The methods and systems also utilize one or more servers with flash media and buffer the media content from the servers to load and start streaming with substantially no load time delay.

### CROSS REFERENCE TO RELATED APPLICATIONS

This application claims the benefit of U.S. Provisional Application Ser. No. 61/352,649 filed Jun. 8, 2010 and U.S. Provisional Application Ser. No. 61/352,657 filed Jun. 8, 2010 and the entire contents therein are hereby incorporated by reference.

### FIELD OF THE INVENTION

Embodiments disclosed herein generally relate to multimedia streaming, and more particularly to improving on-demand streaming to provide good quality images on a wide variety of computers with different hardware and operating system constraints.

### BACKGROUND

Many households and businesses have computers to stream media content via the internet. However, these computers have a wide variety of hardware and software constraints such as would be imposed by different operating systems including but not limited to MICROSOFT WINDOWS® (Microsoft Corporation, Redmond, Wash.), MAC OS® (Apple Computer Inc., Cupertino, Calif.), and LINUX (developed under GNU Public License). As technology and methods for multimedia streaming have rapidly advanced, many improvements demand more and more of computer hardware and software.

Because many newer and improved methods and systems for real-time on-demand multimedia streaming require updated video cards, software, and more computer memory, various of hardware, software, and operating system constraints can limit the ability of users of such computers to stream good quality multimedia. In particular, the requirements for improved multimedia streaming are incompatible with older personal computers and the like.

Accordingly, there is need for improvement in good quality real-time on-demand multimedia streaming available to more computer users, not only those with updated hardware and software. This disclosure describes simplified methods and systems that enable streaming to more computers without loss of quality, delays, or burdening computer processers.

### SUMMARY

The exemplary embodiments described herein provide for improved multimedia streaming that balances quality with accessibility from a wide variety of computer processors.

The disclosed methods and systems obtain media content for streaming from at least one server with flash media. In some embodiments, a content delivery network (CDN) of edge servers is utilized in conjunction with the one or more servers with flash media in order to copy the streaming media content to a location physically closer to a user. A user's computer (client) is used to buffer the media content before streaming such that there is substantially no load time delay. In some embodiments, this is achieved by buffering at least 3 seconds ahead of the displayed streaming content. To maintain a smooth non-delayed streaming experience, media content can then be buffered by utilizing all the available bandwidth once streaming has begun.

The methods and systems disclosed herein display streaming media content on a user's computer via a media player. In some embodiments the media player can be loaded onto a client computer, but in other embodiments no software is required except an internet browser which can access the media player along with the media content. The media player utilizes a custom-sized frame with a predefined pixel aspect ratio, a predefined frame-rate, a progressive order, a predefined number of reference frames, a predefined average variable bit rate, and a predefined maximum variable bit rate. For example, in some embodiments, the predefined pixel aspect ratio can be 1, the predefined frame rate can be 29.97 frames per second, and/or the predefined number of reference frames can be two. In addition, in some embodiments, the predefined average variable bit rate can be 384,000 bits per second and the predefined maximum variable bit rate can be 768,000 bits per second.

The display of streaming media content in the disclosed methods and systems can be further improved for various formats, including but not limited to, MP4, OGG, OGV, and HTML 5. For example, methods and systems disclosed herein can be improved for MP4 format by utilizing a custom-sized frame of 464×352 pixels. In addition, embodiments can be improved for MP4 widescreen format by utilizing a custom-sized frame of 522×304 pixels.

The media player used for streaming media content by the methods and systems described in this disclosure can have a user interface that includes a control bar of a specific size (in some embodiments 375 pixels) nested in a vector image and a seeker to track the present percentage of buffered media content that has already been played along the control bar.

In some embodiments, the seeker moves along the control bar at a rate of 375 pixels divided by the duration of the video. The position of the seeker along the control bar can be updated at least every 800 milliseconds. In addition, in some embodiments, the seeker can have navigational functionality to skip the streaming content forward or backwards along the control bar. The location of the seeker along the control bar can be computed by the location of the client computer's mouse cursor divided by a specified number (for example without limitation, 300 or 375) and further divided by the elapsed duration of said media content that has already been streamed.

In certain embodiments, a control bar can also have buttons to control the streaming media content display, including without limitation, hide, play, and sound buttons. These buttons can be incorporated into the control bar by adding additional pixels to the control bar, for example without limitation, 140 pixels.

### BRIEF DESCRIPTION OF THE DRAWINGS

FIG. 1 is a flowchart showing an exemplary method of streaming media content.

FIG. 2 is a schematic diagram of an exemplary control bar and seeker on a user interface of an exemplary media player.

### DETAILED DESCRIPTION

Real-time and on-demand streaming of media content delivered over the internet has become increasingly popular. Consequently, streaming technology has rapidly advanced. Typically, however, advances in streaming technology demand more of computer hardware and software, burdening the processors of older computers and making streaming advances unavailable to users who do not have updated video cards, hardware, memory, and the like. Described herein are systems and methods for real-time on-demand multimedia streaming that displays good quality media content, but that is available to users of almost any computer, including computers with some older processors. Improved streaming for a variety of computers with different hardware and software constraints is primarily achieved by simplifying the process by which the disclosed media player embodiments function.

The methods and systems for real-time on-demand streaming disclosed herein utilize a media player, which can comprise of a means to initiate retrieval and processing of streaming media content from one or more servers with flash media, means of buffering and decoding and/or decompressing received media content, predetermined settings for improving playback quality of a variety of media content file formats, and a user interface that facilitates the display of streaming media content. Some embodiments of the disclosed methods and systems are known as GIBBYSTREAM® (Gibby Media, Spokane, Wash.).

“Media content” as used herein generally refers to videos, but also applies to other types of streaming media content, including but not limited to music, games, articles, books, and audio content.

“Real-time” as used herein generally refers to the updating of information at essentially the same rate as the data is received. More specifically, “real-time” is intended to mean that the media content is acquired, processed, and transmitted from the one or more server with flash media and buffered by a user's computer at a high enough data rate and at a low enough time delay that the media content can be displayed smoothly without user-noticeable judder, latency, or lag.

“On-demand” as used herein generally refers to media content available via streaming whenever a user wants to view or listen to that media content.

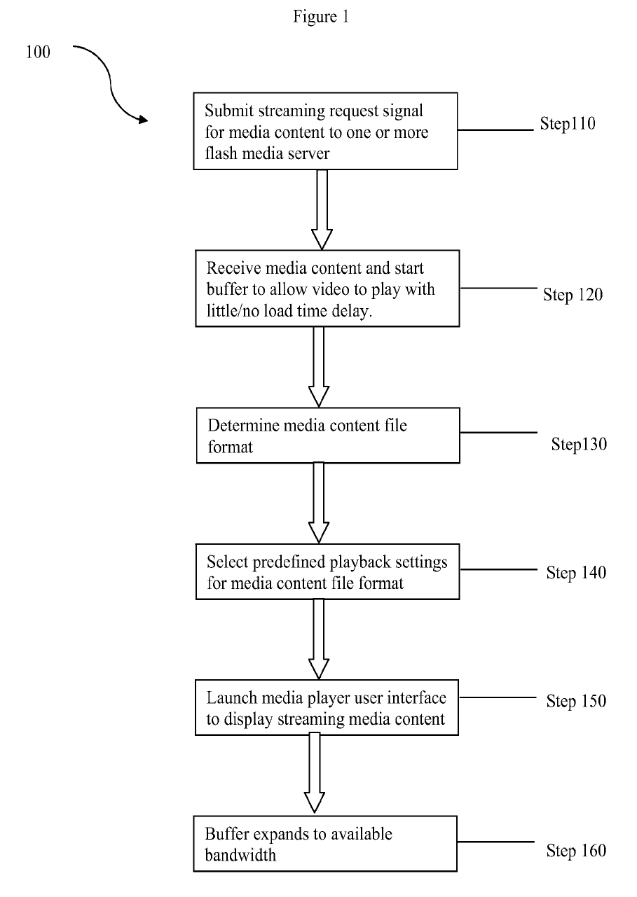

FIG. 1 is flowchart showing exemplary method 100 of simplified real-time and on-demand streaming for computers with a variety of software and hardware constraints. Method 100 can be used with the systems described herein. Method 100 is illustrative and non-limiting in that although it uses particular steps described in a particular order, the present disclosure includes methods incorporating other steps or omitting one or more of the depicted steps or proceeding in different orders.

At step 110, a user's computer sends a request signal via the internet for media content to be streamed. One or more servers is with flash media is used to transfer media content to a user's computer (client). Exemplary embodiments of the methods and systems described herein can have, but do not need to have, flash media on the client computer. Accordingly, the methods and systems are compatible with a wide variety of processors and do not require intensive processing power because only a browser is necessary—no additional software—is needed.

In some embodiments a content delivery network (CDN) is utilized in conjunction with one or more servers with flash media. A CDN uses one or more edge servers located physically closer to the user to deliver the media content. The physical proximity of the media content improves the speed at which the media content can be obtained and streamed because it reduces network congestion and delays that can be caused by high server load. In embodiments which utilize a CDN, media content is streamed directly from an edge server to a user's computer (client).

At step 120, a user's computer (client) receives media content from at least one server with flash media. Received media content can be buffered by a media player to allow a user interface of the media player to load and stream that media content with substantially no load time. For example, without limitation, in some embodiments the media content appears to stream instantaneously. Typical media players buffer content about one quarter (¼) of a second ahead of the content being played. The exemplary embodiments disclosed herein buffer media content at least three (3) seconds ahead of the displayed media content, or in some embodiments at least five (5) seconds ahead or at least ten (10) seconds ahead.

At step 130, an exemplary media player on a client determines the file format of the received media content. An exemplary media player can decode and/or decompress a variety of video and audio file formats. Exemplary video file formats that can be decoded and/or decompressed can include, but are not limited to, Moving Pictures Experts Group 4 (MPEG-4 or MP4), Audio Video Interleave File (AVI), Windows Media File (WMV), QuickTime Video Clip (MOV), and 3rd Generation Multimedia File (3GP). Exemplary audio file formats include, but are not limited to, Ogg Vorbis Codec Compressed Multimedia File (OGG) and Ogg Vorbis Video Profile (OGV). In some embodiments, modules of a media player may include executable files for one or more operating systems. For example, without limitation, a WINDOWS execution module can comprise of a list of commands to allow a computer using a WINDOWS operating system to execute commands and decode the video and/or audio files using a media player that is compatible with WINDOWS.

At step 140, an exemplary improvement module of an exemplary media player selects predefined playback settings for increased quality streaming of media content of a specific file format, for example, without limitation, MP4, OGG, OGV, or HTML 5 formats. The improved playback settings disclosed herein reduce bandwidth required to stream media content and improve the quality of displayed media content. Exemplary improved playback settings can include, but are not limited to, a custom frame size, a predefined pixel aspect ratio, a predefined frame-rate, a progressive order, a predefined number of reference frames, a predefined average variable bit rate, and a predefined maximum variable bit rate. In part, the improved playback settings of the exemplary systems and methods disclosed herein produce good quality streaming displays at low variable bit rates, reducing bandwidth used for streaming.

In some embodiments, improved playback settings can include a predefined pixel aspect ratio of 1. In addition, some embodiments can include a predefined frame rate of 29.97 frames per second and/or a predefined number of two (2) reference frames. Other embodiments can include a predefined average variable bit rate of 384,000 bits per second and/or a predefined maximum variable bit rate of 768,000 bits per second.

Improved playback settings are selected from within the standard range for a specific file format. For example, but without limitation, MP4 files can have a pixel aspect ratio between 0.9091 and 1.333, a frame rate between 12.0 and 29.97, and a bit rate between 0 and 240,000,000. Because Improved playback settings are selected from within the standard ranges, an exemplary improved frame rate for MP4 files can be 29.97 frames per second, but in some embodiments at least 25 frames per second. Similarly, settings for increased playback quality of OGG, OGV, HTML 5, and other file formats are also selected from within the standard ranges for those particular formats.

Playback settings for increased quality streaming can also include custom-sized frames for specific file formats, including, but not limited to, MP4, AVI, WMV, MOV, 3GP, OGG), OGV, or HTML 5. For example, but without limitation, a frame size for MP4 files can be about 464×352 pixels, about 320×240 pixels, or about 640×480 pixels or a frame size for MP4 widescreen files can be about 522×304 pixels.

At step 150, initial buffering of media content is complete and a user interface of an exemplary media player is launched to enable the display of real-time streaming media content. The user interface enables a user not only to view streaming media content but also to interact with a media player and to control playback of streaming media content by, for example, pausing the display.

At step 160, continued buffering of streaming media content can be expanded to utilize the full available bandwidth. In some embodiments, the buffer can be expanded up to 100 seconds of media content.

Exemplary real-time on-demand multimedia streaming systems disclosed herein utilize at least one server with flash media, a client computer to review and display media content, and a media player that improves playback settings including, but not limited to, frame size, pixel aspect ratio, frame-rate, order, number of reference frames, average variable bit rate, and variable bit rate. Some system embodiments can also include a CDN network of edge servers.

Exemplary system embodiments can be used to perform improved methods of streaming media content, for example, but not limited methods such as that depicted and described in FIG. 1. For example, systems disclosed herein can be used to retrieve and transfer media content and decode and/or decompress media content of different file formats, including but not limited to MP4, AVI, WMV, MOV, 3GP, OGG, OGV, or HTML 5. Disclosed systems can also be used to buffer media content and improve playback and display settings for different file formats, including without limitation, MP4, AVI, WMV, MOV, 3GP, OGG, OGV, or HTML 5 formats.

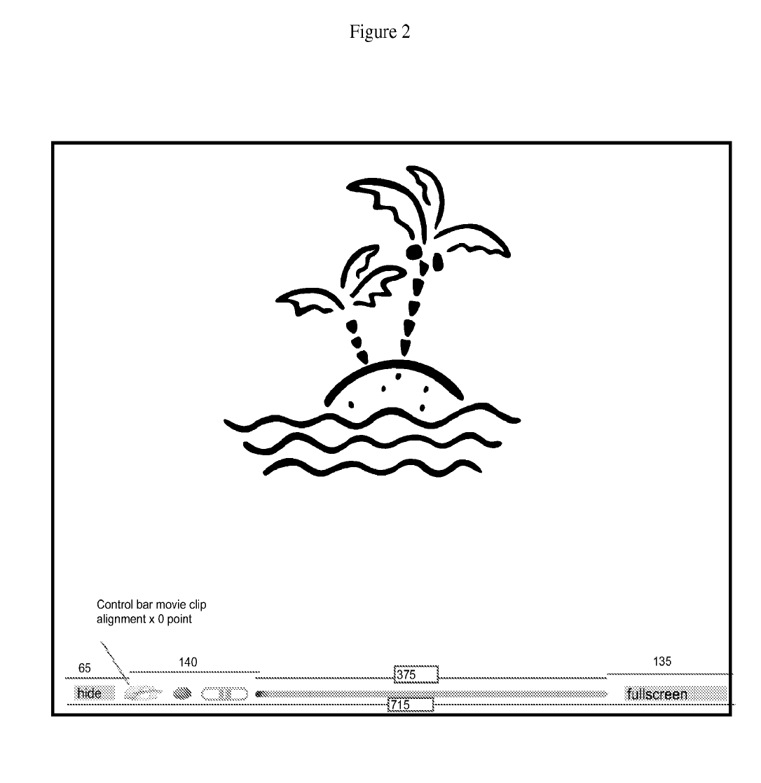

FIG. 2 is a schematic diagram of exemplary user interface 200 of a media player, which is part of the disclosed methods and systems. Exemplary user interface 200 includes control bar 210 nested in a vector image and seeker 220. Seeker 220 has navigational functionality and can track a present percentage of buffered media content that has been played along control bar 210. In some embodiments, control bar 210's vector image is 375 pixels. In some embodiments, seeker 220's rate of movement along control bar 210 at a rate of 375 pixels divided by the duration of the video.

In the disclosed systems and methods, seeker 220's navigational functionality allows a user to select the starting point of the streaming media content at a particular time or to move the seeker, and thus the content being played, forward or backward along the control bar. The location of exemplary seeker 220 on control bar 210 when it has been moved by a user can be recomputed by the location of a user's mouse cursor divided by a specified number and further divided by the elapsed duration of the media content already streamed. This simple calculation of location reduces the processing time and capacity necessary to locate seeker 220, thus increasing speed and ability to stream media content even on older computers. In certain embodiments, the specified number that serves as a numerator in calculating seeker 220's location can be about 300. In other embodiments the specified number can be any number between 250 and 400, for example without limitation, 375. The location of seeker 220 can be frequently updated by the media player checking the elapsed time of the streaming media content.

In certain exemplary systems and methods, seeker 220's location is updated at least about every 900 milliseconds, in some embodiments at least about every 800 milliseconds, and in other embodiments at least about every 700 milliseconds. The rate at which seeker 220's location is updated reduces the lag time in identifying the amount of buffered media that has been played without burdening the computer processor.

User interface 200 of an exemplary media player in the disclosed systems and methods of streaming can also have various control buttons. For example, pause/play button 230 allows a user to start, pause, or reinitiate the streaming of media content, and hide button 240 can allow a user to hide the control bar. Sound button 250 allows a user to control audio volume during streaming. Pause/play button 230, hide button 240, and sound button 250 add to the size of the nested vector image containing control bar 210. In certain embodiments, pause/play button 230, hide button 240, and sound button 250 can add an additional 140 pixels to the nested vector image. In other embodiments, the size of these control buttons can be less than or more than 140 pixels, for example, without limitation, 50 pixels, 200 pixels, 205 pixels, 300 pixels, 340 pixels, or 400 pixels. Embodiments with only a few buttons can take less space than 140 pixels, for example without limitation, 50 pixels or 65 pixels.

Some embodiments can also include a fullscreen button 260, which allows the streaming window to be expanded to the size a user's entire computer screen. Fullscreen button 260 can add additional pixels to the nested vector image, for example without limitation, 135 pixels. In fullscreen mode, the displayed media content remains in proportion to the custom-sized frame (for example, without limitation, 464×352 pixels), and the computer's graphics card is utilized to expand the display to occupy the entire screen.

Certain user interface embodiments of the disclosed methods and systems can also include control buttons in addition to, or instead of, depicted pause/play button 230, hide button 240, sound button 250, and fullscreen button 260. For example, a time button (not shown) can be used to display the elapsed time and/or the remaining time of the streaming content. Other embodiments can include an exit button (not shown) to allow a user to exit the streaming playback of media content and/or loop button (not shown) to enable a user to replay the streaming media content. Exemplary media players can also contain commands, either on their user interfaces or in their properties, to customize other display settings for the streaming media content. Such display settings can include, but are not limited to, adjusting the contrast, brightness, sharpness, and/or other common screen settings.

Unless otherwise indicated, all numbers expressing quantities and/or properties such as resolution and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the exemplary embodiments (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the exemplary embodiments and does not pose a limitation on the scope of the exemplary embodiments otherwise claimed. No language in the specification should be construed as indicating any non-claimed element essential to the practice of the exemplary embodiments.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

In closing, it is to be understood that the exemplary embodiments disclosed herein are illustrative of the principles of the present disclosure. Other modifications that may be employed are within the scope of the disclosure. Thus, by way of example, but not of limitation, alternative configurations of the present exemplary embodiments may be utilized in accordance with the teachings herein. Accordingly, the present exemplary embodiments are not limited to that precisely as shown and described.

We claim:

1. A method of improving multimedia streaming comprising steps of:
obtaining media content via the internet from at least one server with flash media;
buffering said media content into a buffer at least three seconds ahead of a display of said media content to allow a user interface of a media player to load and start streaming said media content on a computer with substantially no load time delay;
expanding said buffer of said media content to accept data at all of the available bandwidth once said media content starts streaming;
displaying said media content on said computer via said media player, wherein said media player utilizes a custom-sized frame with an predefined pixel aspect ratio, a predefined frame-rate, a progressive order, a predefined number of reference frames, a predefined average variable bit rate, and a predefined maximum variable bit rate.

2. The method according to claim 1 wherein said at least one server with flash media utilizes a content delivery network (CDN) comprising edge servers to copy said media content physically closer to an end-user.

3. The method according to claim 1 wherein said user interface of said media player comprises a control bar nested in a vector image and a seeker to track a present percentage of buffered media content that has been played along said control bar, wherein said vector image is a predetermined number of pixels in length, and wherein said seeker's rate of movement along said control bar is the predetermined number of pixels divided by the duration of said media content.

4. The method of claim of claim 3 wherein the predetermined number of pixels is 375.

5. The method according to claim 3 wherein the location of said seeker along said control bar is updated at least every 800 milliseconds.

6. The method according to claim 3 wherein said seeker has navigational functionality to be moved to specific points along said control bar and the location of said specific points is computed by the location of a mouse cursor of said computer divided by three hundred and further divided by the elapsed percentage of buffered media content that has already been played.

7. The method according to claim 3 wherein said control bar further comprises hide, pause/play, and sound buttons.

8. The method according to claim 1 wherein said predefined pixel aspect ratio is 1, said predefined frame rate is 29.97 frames per second, and said predefined number of reference frames is two.

9. The method according to claim 1 wherein said predefined average variable bit rate is 384,000 bits per second and said predefined maximum variable bit rate is 768,000 bits per second.

10. The method according to claim 1 improved for MP4 format wherein said custom-sized frame is 464×352 pixels.

11. The method according to claim 1 improved for MP4 widescreen format wherein said custom-sized frame is 522×304 pixels.

12. The method according to claim 1 improved for .ogg format, .ogv format, or html 5 format.

13. A real-time on-demand multimedia streaming system, said system comprising:
at least one server with flash media;
a computer to buffer and display media content obtained via the internet from said at least one server with flash media;
a media player for streaming said media content on said computer, wherein said media player comprises a user interface and utilizes a custom-sized frame with a predefined pixel aspect ratio, a predefined frame-rate, a progressive order, a predefined number of reference frames, a predefined average variable bit rate, and a predefined maximum variable bit rate.

14. The multimedia streaming system according to claim 13 wherein said at least one server with flash media utilizes a content delivery network (CDN) of edge servers to copy said media content physically closer to an end-user.

15. The multimedia streaming system according to claim 13 wherein said user interface of said media player comprises a control bar nested in a vector image and a seeker to track a present percentage of buffered media content that has been played along said control bar, wherein said vector image is a predetermined number of pixels in length, and wherein said seeker's rate of movement along said control bar is the predetermined number of pixels divided by the duration of said media content and the location of said seeker is updated at least every 800 milliseconds.

16. The multimedia streaming system of claim 15 wherein the predetermined number of pixels is 375.

17. The multimedia streaming system according to claim 15 wherein said seeker has navigational functionality to be moved to specific points along said control bar and the location of said specific points is computed by the location of a mouse cursor of said computer divided by three hundred and further divided by the elapsed percentage of buffered media content that has already been played.

18. The multimedia streaming system according to claim 13 wherein predefined pixel aspect ratio is 1, said predefined frame rate is 29.97 frames per second, said predefined number of reference frames is two, said predefined average variable bit rate is 384,000 bits per second and said predefined maximum variable bit rate is 768,000 bits per second.

19. The multimedia streaming system according to claim 13 improved for MP4 format wherein said custom-sized frame is 464×352 pixels.

20. The multimedia streaming system according to claim 13 improved for MP4 widescreen format wherein said custom-sized frame is 522×304 pixels.

21. The multimedia streaming system according to claim 13 improved for .ogg format, .ogv format, or html 5 format.
